(19) United States
(12) Patent Application Publication
(10) Pub. No.: US 2008/0256508 A1
(43) Pub. Date: Oct. 16, 2008

(54) Hybrid Spreadsheet/Workflow Design and Execution Environment

(75) Inventor: Gunnlaugur Jonsson, Kopavogur (IS)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Einfalt, ehf., Reykjavik (IS)

(21) Appl. No.: 12/114,175

(22) Filed: May 2, 2008

Related U.S. Application Data
(63) Continuation-in-part of application No. 10/682,441, filed on Oct. 9, 2003.
(60) Provisional application No. 60/927,270, filed on May 2, 2007.

(51) Int. Cl. G06F 9/44

(52) U.S. Cl. 717/104

(57) ABSTRACT

The present invention provides a user-friendly visual programming and modeling environment with a spreadsheet interface. The invention allows the creation of complex software applications and programs in real-time. A user with no programming skills can easily develop software programs. A hybrid workflow diagram and execution environment is created using a spreadsheet. The workflow and the spreadsheet cause variables in the spreadsheet cells to be manipulated. The hybrid workflow design and execution environment are used to implement computer readable code to create new executable software applications.

### RELATED APPLICATIONS

This application is claims priority to U.S. Provisional Application No. 60/927270, filed May 2, 2007 and is a Continuation-in-Part of U.S. application Ser. No. 10/682,441, filed Oct. 9, 2003, the entire teachings of which are incorporated herein by reference.

### BACKGROUND

Electronic spreadsheets are a popular computer tool for handling data. A number of spreadsheet programs have been on the market, for example, Microsoft Excel, Corel Quattro Pro and Lotus 1-2-3. Electronic spreadsheets can store data and make calculations from the data by using functional relationships that are defined in the cells of the spreadsheets. “Cells” of spreadsheets store individual variables that can be used in these calculations.

Electronic spreadsheet programs may also include programming or “macro” capabilities that expand the program's functionality, for example, for creating and sorting databases. Excel, for instance, uses the programming language Visual Basic for implementing macros. Before Visual Basic, Excel used a macro language that executed code located in the cells of a spreadsheet.

### SUMMARY

It is common for businesses to use spreadsheets to handle data and create “macros” or code that enhances the abilities of the spreadsheet. Writing such code requires knowledge and training that not everybody has. Making it easier and simpler to create “macros”, even without writing code, is therefore quite valuable.

The present method and apparatus provide a user-friendly programming environment that can enable the creative design of custom software products. With the invention, users can design their own custom software and even their own custom approach for making software development a rational industrial process. The present invention can expand the possibilities in spreadsheets beyond conventional macro languages.

The invention can be viewed as a spreadsheet program, which is a general programming tool with vast capabilities. The invention could also be implemented as an add-on to other spreadsheet programs, extending their capabilities. In embodiments of the invention, these capabilities are extended to create an object-oriented programming system. This system enables a user to create a software program that is a collection of discrete objects, which are self-contained collections of data structures and routines that interact with other objects. This system represents objects using spreadsheets.

The invention relates to an approach to software programming. A hybrid workflow diagram and execution environment is created using a spreadsheet. The workflow and the spreadsheet cause variables in the spreadsheet cells to be manipulated. The hybrid workflow design and execution environment are used to implement computer readable code to create new executable software applications.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views.

The drawings are not necessarily to scale, emphasis instead being placed upon illustrating embodiments of the present invention.

FIG. 1A is a screenshot of an IfElse activity on the design surface provided by the inventive framework.

FIGS. 1B-1C are screenshots of the Excel user interface integrated with the workflow design in accordance with the present invention.

FIG. 1D is a screenshot of an IfElse activity in connection with the spreadsheet interface provided by the inventive framework.

FIGS. 2A-2G are screenshots of examples of activities that control the flow of execution in a workflow provided by the inventive framework.

FIGS. 3A-3D are screenshots of examples of event handling activities that enable worksheet events provided by the inventive framework.

FIGS. 4A-4C are screenshots of examples of cell editing activities provided by the inventive framework.

FIG. 5 shows a cell assignment activity in connection with the spreadsheet interface provided by the inventive framework.

FIG. 6 is a block diagram of an example implementation of the present hybrid spreadsheet workflow design and execution system.

FIG. 7 is a block diagram of a computer network or similar digital processing environment in which the present invention may be implemented.

FIG. 8 is a block diagram of the internal structure of a computer in which the present invention may be implemented.

### DETAILED DESCRIPTION OF THE INVENTION

A description of example embodiments of the invention follows. The present invention provides a user-friendly visual programming and modeling environment with a spreadsheet interface. The invention allows the creation of complex software applications and programs in real-time. A user with no programming skills can easily develop software programs. A hybrid workflow diagram and execution environment is created using a spreadsheet. The workflow and the spreadsheet cause variables in the spreadsheet cells to be manipulated. The hybrid workflow design and execution environment are used to implement computer readable code to create new executable software applications.

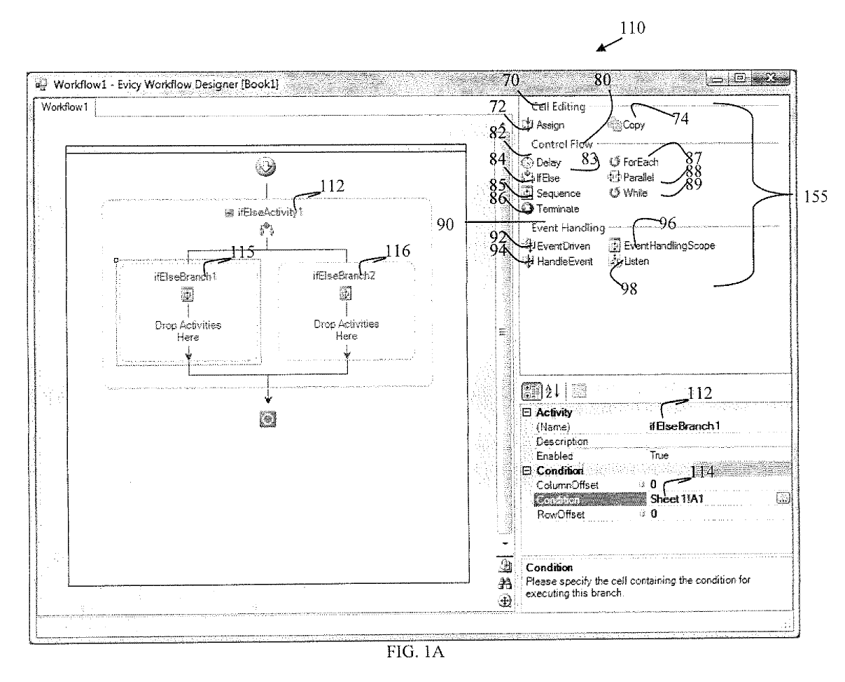

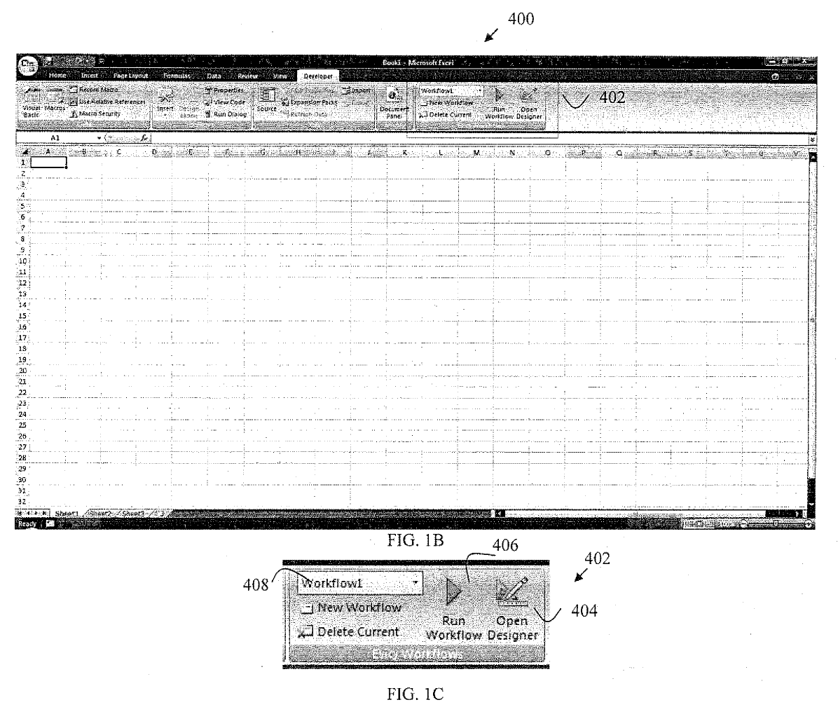

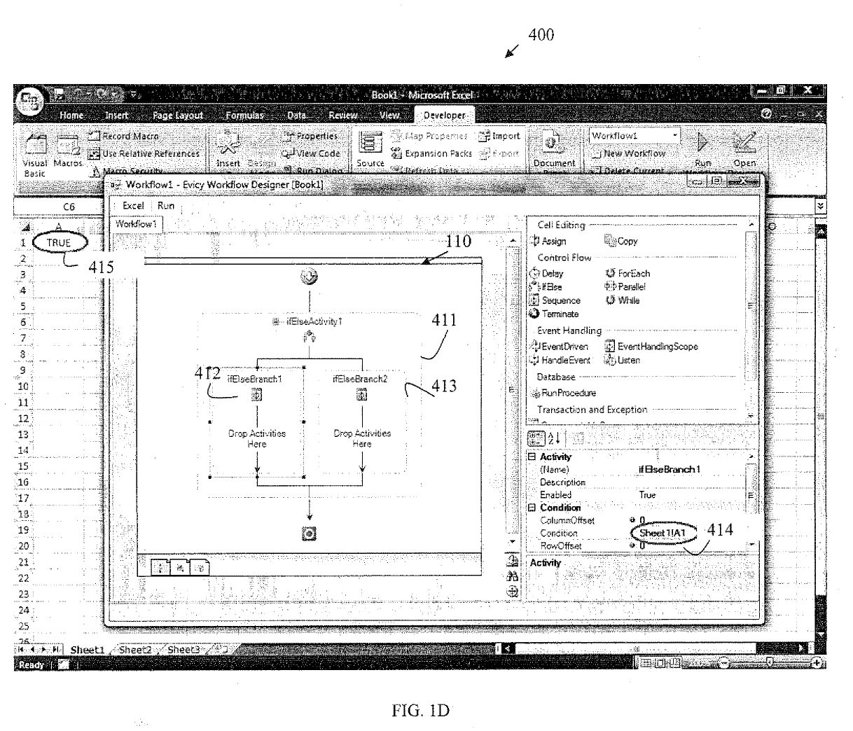

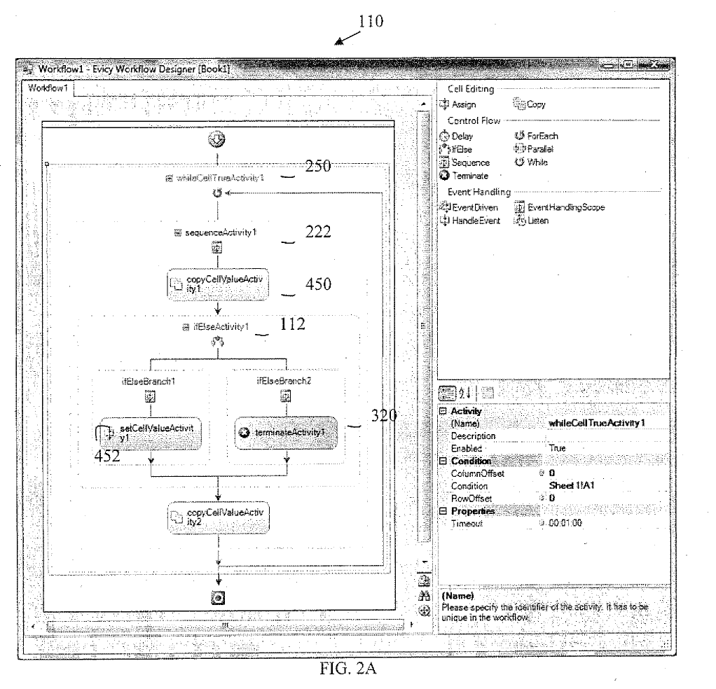

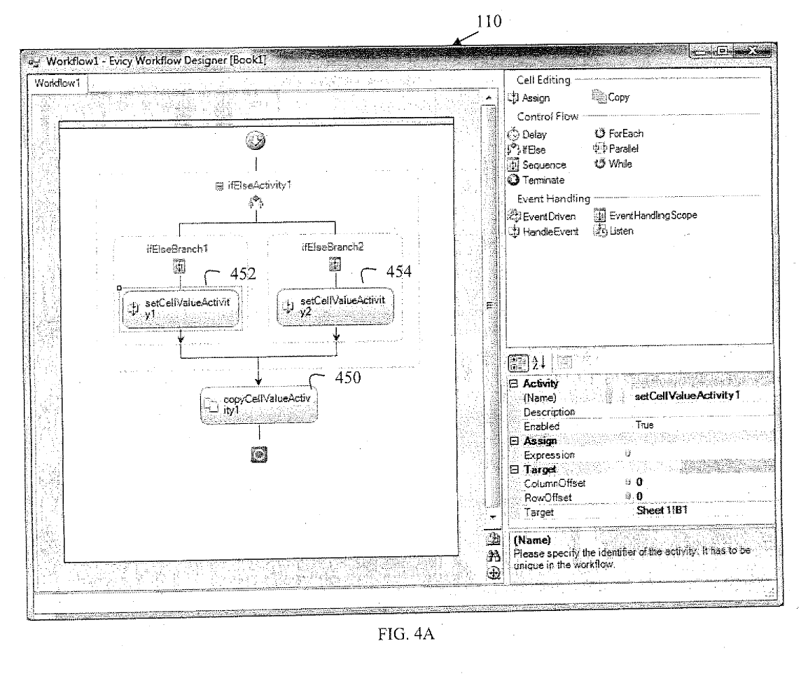

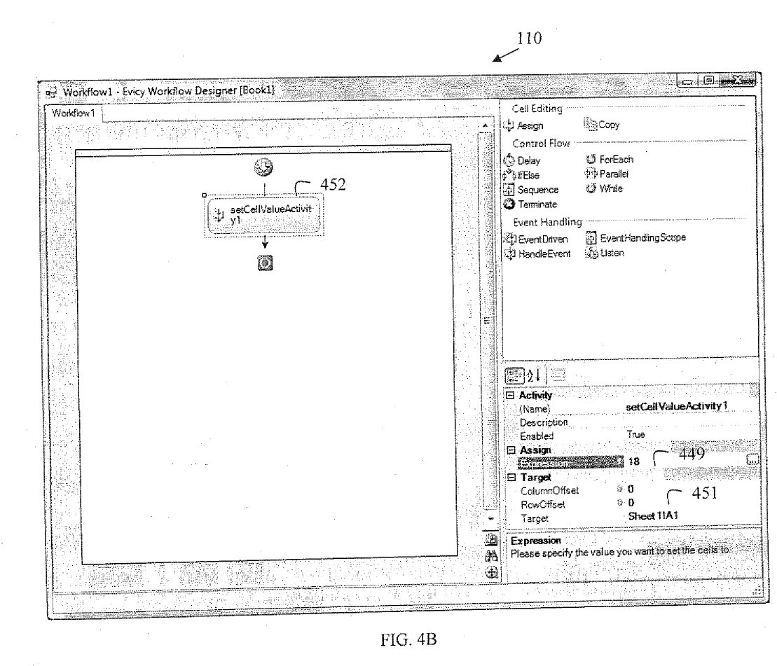

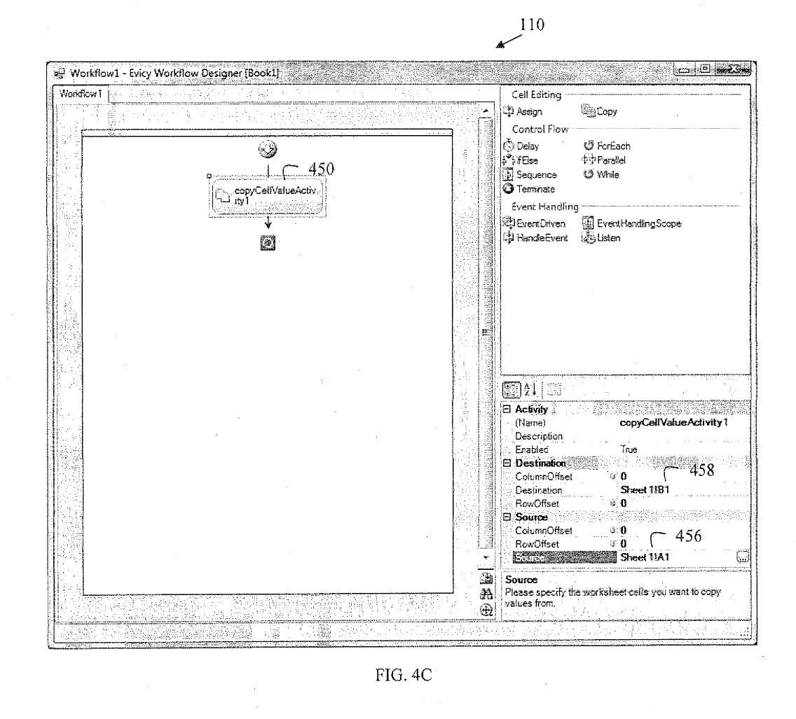

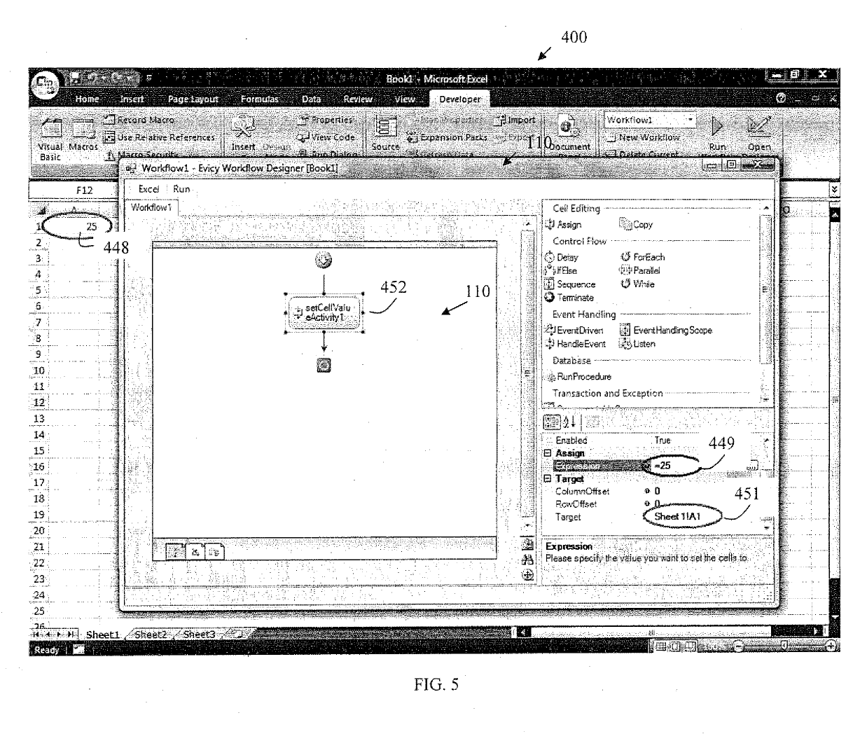

In an example implementation of the invention, the spreadsheet and the workflow can be Microsoft products. First, there is Microsoft Excel, a spreadsheet program that handles variables in a very user friendly, efficient and elegant way. Other spreadsheet programs function in a similar way. Second, there is Microsoft Workflow Foundation, a framework for software developers to use for graphically constructing algorithms and other structured operations. Microsoft Workflow Foundation does that by enabling the user to create activities (e.g. ordered tasks or units of work) using a designer for organizing components visually. For example there are special components for loops, if statements, event handling, etc. In addition, developers can program custom activities for use in the framework. The Workflow Foundation design environment can also be integrated in an application for allowing end users to graphically construct workflows using provided activities. An IfElse activity 112, for example as in FIG. 1A, contains branches 115, 116 that are executed based on their conditions. As shown in FIG. 4, other activities can be included in the branches 115, 116 of the IfElse activity. Further details regarding these activities are provided below.

Microsoft Workflow Foundation includes a programming model, engine and tools for building workflow enabled applications on Windows. Microsoft Workflow Foundation includes support for both system workflow and human workflow for a diverse range of applications including: business applications, user interface page-flow, human workflow, document workflow, composite workflow for service oriented applications, business rule driven workflow, and workflow for systems management. Microsoft Workflow Foundation is discussed in further detail at application Ser. No. 11/047,017, filed Jan. 31, 2005, entitled “Componentized and Extensible Workflow Model,” application Ser. No. 11/063,954, filed Feb. 23, 2005, entitled “Programming Interface for a Componentized and Extensible Workflow Model,” application Ser. No. 11/070,049, filed Feb. 28, 2005, entitled “Visual Workflow Modeling Tools for User Interface Automation,” and application Ser. No. 11/117,808, filed Apr. 29, 2005, entitled “Workflow Hosting Computing System Using a Collaborative Application,” the entire teachings of which are incorporated by reference.

The present invention employs Microsoft Workflow Foundation to provide many other different activities that are combinable in a sequential workflow as seen in the Figures and together they control a process or algorithm. Activities are the building blocks of workflow and provide a unit of work that needs to be executed.

The present invention enables a user or a developer to create a sequential workflow within a spreadsheet environment. The variables that activities of the workflow refer to are contained in cells on a spreadsheet. For example as discussed in more detail below in connection with FIG. 1D, the conditions 414 for executing branches 412, 413 of an IfElse activity 411 can refer to the value of a cell 415 in a spreadsheet. In addition, the invention provides new custom activities, such as CopyCellValueActivity 450 and SetCellValueActivity 452, 454, which are shown in FIG. 4, that enable the contents of spreadsheet cells to be manipulated from a workflow. Using this inventive framework, a hybrid of a spreadsheet and a workflow design and execution environment can be provided.

Both the workflow and the spreadsheet can affect the variables in spreadsheet cells. For example, a spreadsheet uses formulas to define a constant relationship between different variables and a workflow sequence and can, for example, define a dynamic relationship and elaborate order of processing. The combined use of a spreadsheet and a workflow can be compared to the combined use of a spreadsheet and macros that contain code written in a programming language such as Visual Basic for Applications. However, Applicant has discovered that the use of workflows instead of code is a more user friendly approach. In addition, the concept of creating a workflow programming environment using a spreadsheet to define the behavior of software being designed provides a user friendly/developer friendly, comprehensive and versatile programming environment.

The invention is not limited to these examples but in general enables many different kinds of interaction between a workflow and a spreadsheet. More examples could include a While activity depending on a condition in a cell, copying values and formulas between cells, the workflow responding to changes in cells and other events in the spreadsheet program, etc. The invention thus can enable the user to do anything in relation to a spreadsheet that a programming language as Visual Basic for Applications currently does, but in a more user friendly way. In this way, the invention creates an integrated development environment using Microsoft Workflow Foundations activities to model and implement software from a user friendly spreadsheet environment.

### Activities

A runtime engine processes activities that are specified in a workflow and then responds based on the result. An example condition-based activity is an IfElse activity. An IfElse statement consists of a condition and one or more resulting actions. FIG. 1A shows an IfElse activity 112 on the design surface 110 provided by the inventive framework. The IfElse activity behaves like a standard If statement. By default the IfElse activity 112 has two branches 115, 116, and new branches can be added. When the runtime engine reaches an IfElse activity it processes the condition of the branches left to right. The execution processes of branches 115, 116 of the IfElse activity 112 can be modified based on the value of the Excel cell 114 specified as condition for each branch. The IfElse activity 112 can include condition-based branches as well as a default branch to handle the case where no other condition is met. In this example, the IfElseBranch1 115 is selected. The behavior of the IfElseBranch1 115 can be modified using the value specified at the address of the Excel cell 114.

FIG. 1D shows an IfElse activity 411 in the context of the spreadsheet interface 400 provided by the inventive framework. Each branch 412, 413 of the activity has an associated condition 414 which refers to a cell 415 in a spreadsheet. When workflow execution reaches the IfElse activity 411, the condition of the leftmost branch is evaluated. If the corresponding spreadsheet cell 415 evaluates to True, then workflow execution continues along that branch. Otherwise, the condition of the next branch is evaluated, and so on for all remaining branches.

Referring back to FIG. 1A, other activities can be included in the branches 115, 116 of the IfElse activity 112. For example, a code activity from the toolbar 155 can be dropped onto the IfElseBranch where it says “Drop Activities Here” 120. The toolbar 155 provides activities related to execution flow control 80, event handling 90, and cell editing 70.

The execution flow control activities 80 provided by the toolbar 155 are activities that control the flow of execution in a workflow. In general, activities used can be divided into two categories, custom activities that interact with Excel, and standard Workflow Foundation activities. Seven execution flow control activities 80 are provided, and three are custom activities, as indicated below:
DelayActivity 82
IfElseActivity 84 (custom activity)
SequenceActivity 85
TerminateActivity 86
ForEachCellActivity 87 (custom activity)
ParallelActivity 88
WhileCellTrueActivity 89 (custom)

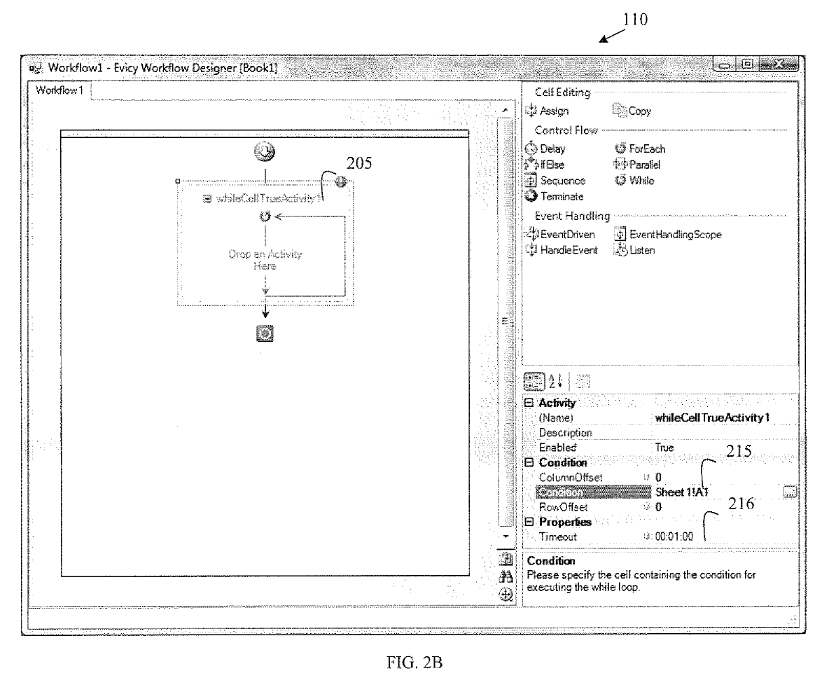

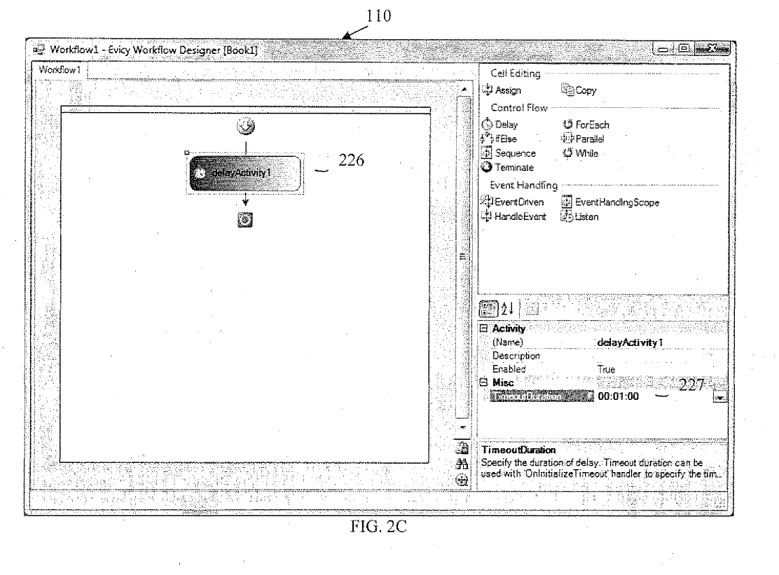

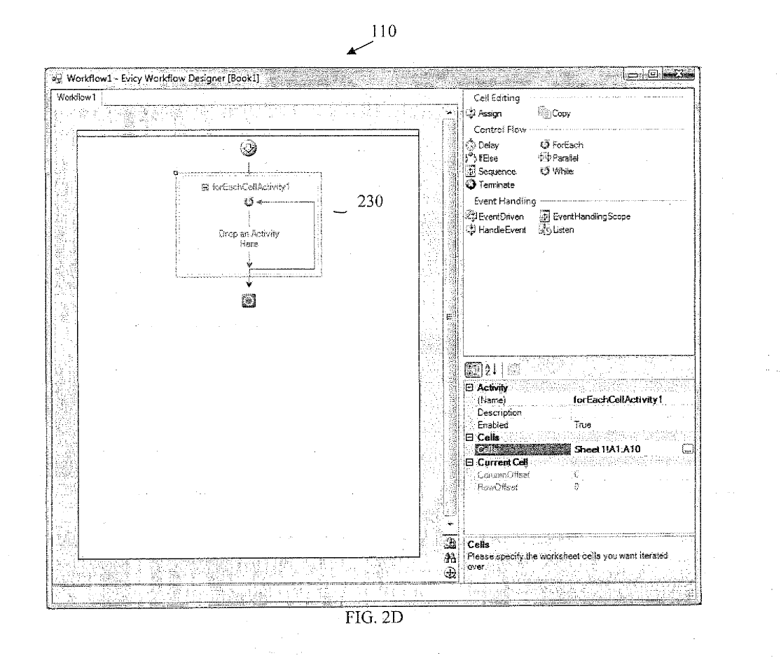

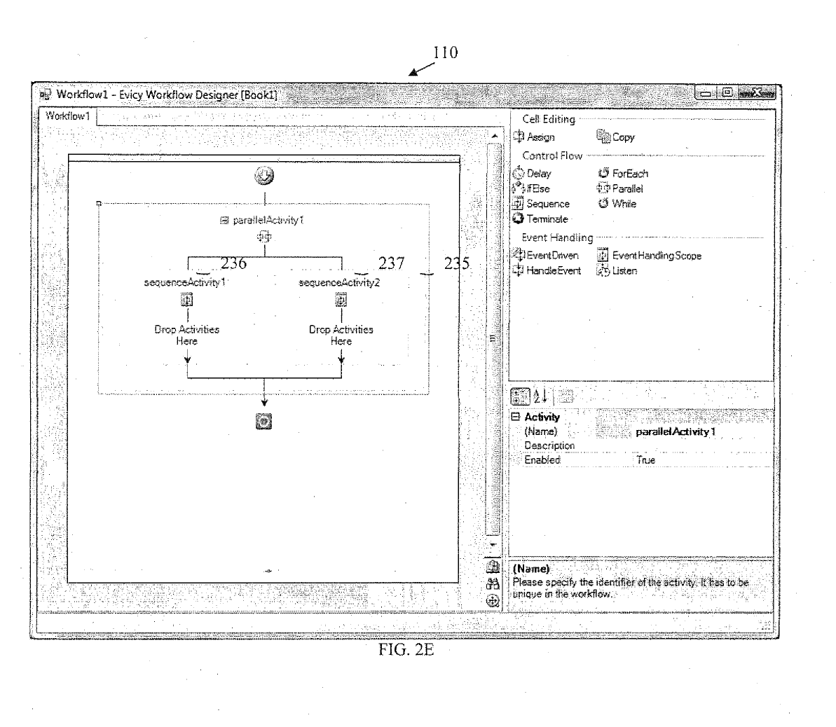

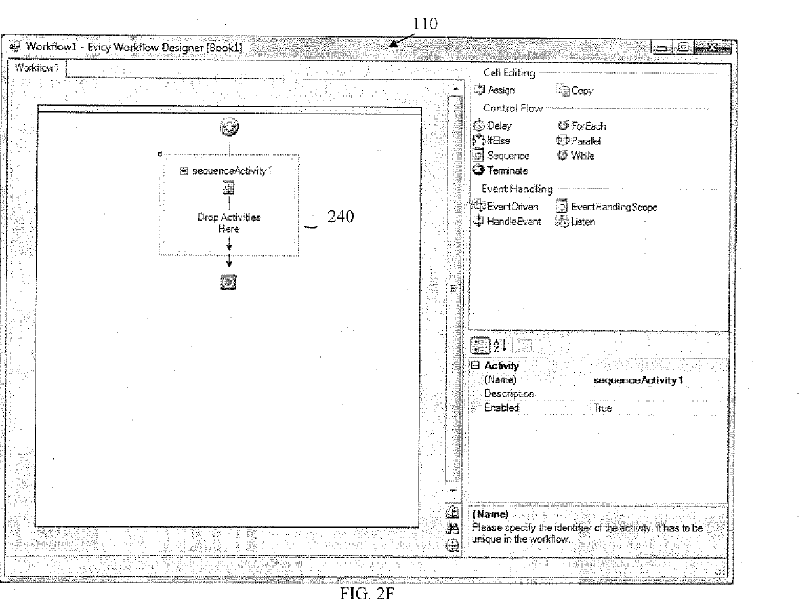

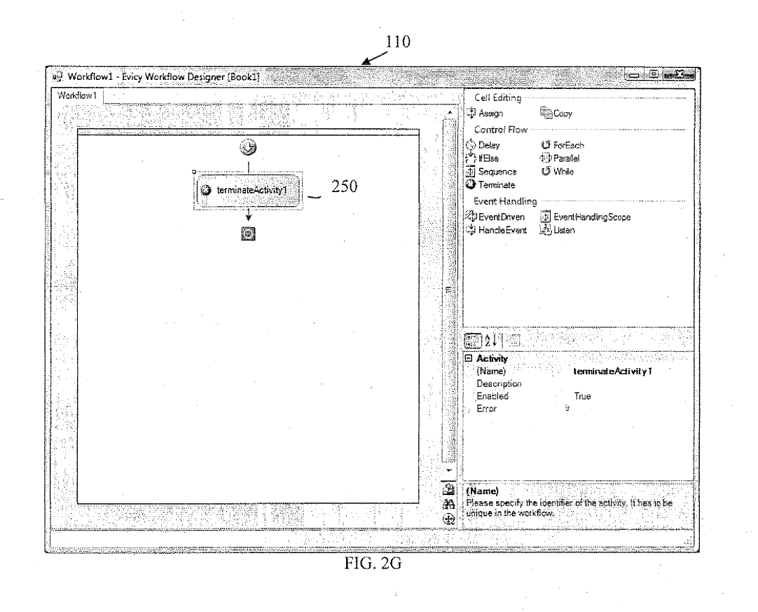

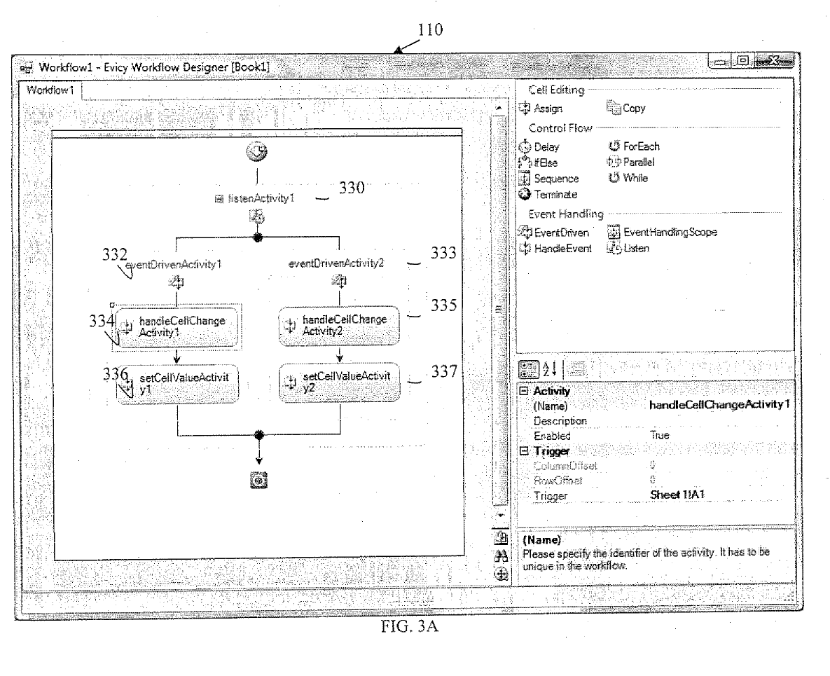

FIG. 2A illustrates an example configuration of some of execution flow control activities. For instance, this workflow shows a configuration of WhileCellTrueActivity 220, SequenceActivity 222, IfElseActivity 112, CopyCellValue 450, IfElseActivity 112, SetCellValueActivity 452, and TerminateActivity 320. These activities are discussed in further detail below.

FIG. 2B is a screenshot of an example While activity (WhileCellTrueActivity) 205. The While activity 205 accepts a condition and processes it at the beginning of each iteration. If the condition is true, the activity runs the specified child activity and repeats until the condition becomes false. In this example, the While activity (WhileCellTrueActivity) 205 executes its child activity over and over until the value of the cell specified as a condition (Condition) 214 becomes False, or until the time specified (Timeout) 216 has elapsed.

FIG. 2C is a screenshot of an example Delay (DelayActivity) 226. The Delay (DelayActivity) 226 delays execution of the workflow until specified time (TimeoutDuration) 227 has elapsed. Delay (DelayActivity) 226 is a standard Workflow Foundation activity.

FIG. 2D is a screenshot of an example ForEach (ForEachCellActivity) 230. The ForEach (ForEachCellActivity) 230 loops through a specified range of Excel cells (Cells), one by one, executing its child activity in each iteration.

FIG. 2E is a screenshot of an example Parallel (ParallelActivity) 235. The Parallel (ParallelActivity) 235 executes the activities contained in its branches 236, 237 in parallel. Parallel (ParallelActivity) 235 is a standard Workflow Foundation activity.

FIG. 2F is a screenshot of an example Sequence (SequenceActivity) 240. The Sequence (SequenceActivity) 240 executes its child activities sequentially. The Sequence (SequenceActivity) 240 is a standard Workflow Foundation activity.

FIG. 2G is a screenshot of an example Terminate (TerminateActivity) 250. Terminate (TerminateActivity) 250 terminates the execution of a workflow.

Referring back to FIG. 1A, the event handling 90 activities provided using the toolbar 155 include four activities that enable handling of worksheet events:
EventDrivenActivity 92
EventHandlingScopeActivity 96
HandleEvent 94 (custom activity)
ListenActivity 98

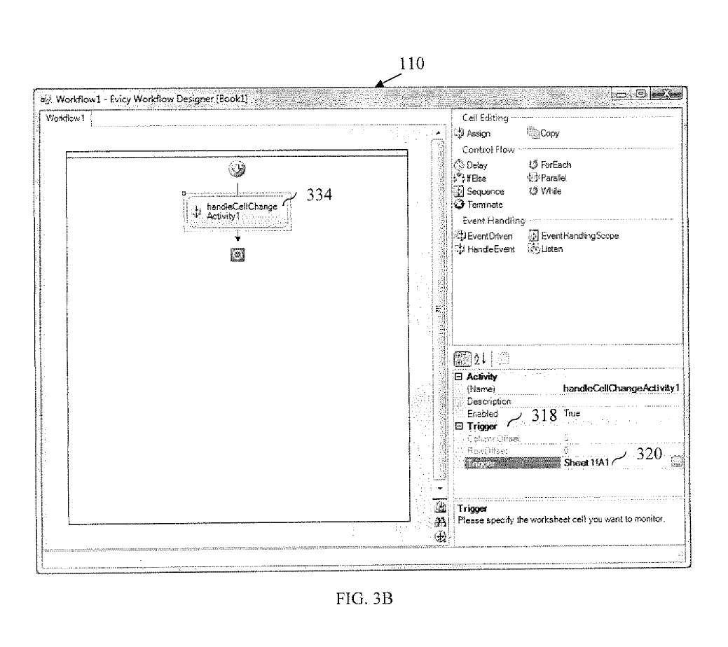

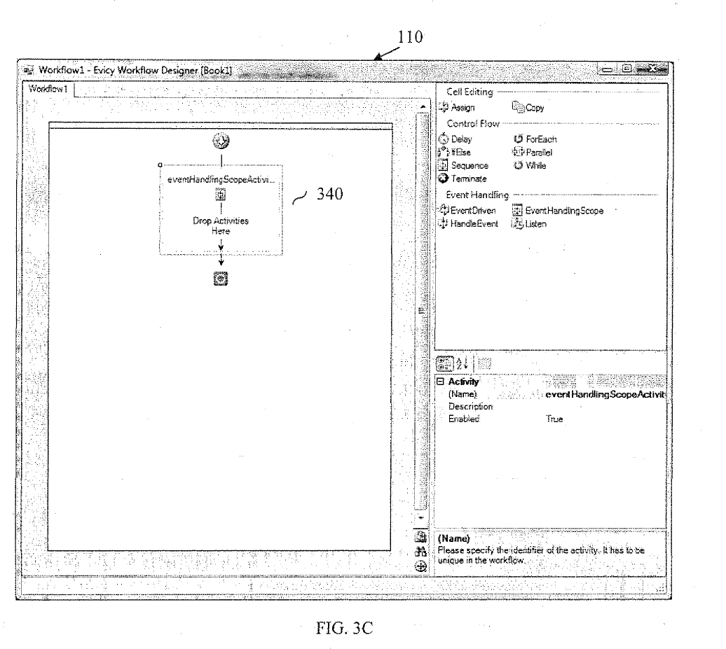

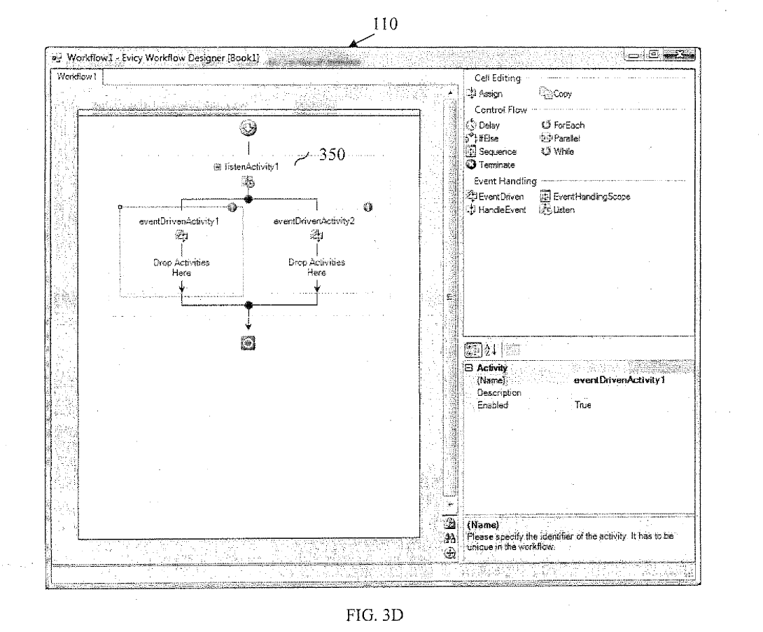

FIG. 3A illustrates an example configuration of some of these worksheet event handling activities. In this example configuration, EventDrivenActivity child activities 332, 333 are branched under Listen (ListenActivity) 330. HandleEvent (HandleCellChangeActivity) activities 334, 335 and Assign (SetCellValueActivity) activities 336, 337 are child activities of EventDrivenActivity activities 332, 333, respectively. These activities are discussed in more detail below.

FIG. 3B is a screenshot of a HandleEvent (HandleCellChangeActivity) 334. The HandleEvent (HandleCellChangeActivity) 334 halts execution of the workflow until an external event occurs. In the example shown in FIG. 3B, the HandleEvent (HandleCellChangeActivity) 334 halts execution of the workflow until the value 320 of specified Excel cell (Trigger) 318 occurs.

FIG. 3C is a screenshot of an EventHandlingScope (EventHandlingScopeActivity) 340. EventHandlingScope 340 executes its main child activity concurrently with an EventHandlersActivity activity. EventHandlingScope 340 is a standard Workflow Foundation activity.

FIG. 3D is a screenshot of a Listen (ListenActivity) 350. The Listen (ListenActivity) 350 is composite activity that contains only EventDrivenActivity child activities. The Listen (ListenActivity) 350 is a standard Workflow Foundation activity. EventDriven (EventDrivenActivity) wrap one or more activities that are executed when a specified event occurs. EventDriven (EventDrivenActivity) activities can here only be contained in a ListenActivity activity 350.

Referring back to FIG. 1A, the cell editing 70 activities provided using the toolbar 155 include two custom activities for changing the values of Excel cells, SetCellValueActivity 72 and CopyCellValueActivity 74. FIG. 4A shows an example configuration of these custom activities. In this example configuration, two branches of SetCellValueActivity 452, 454 and CopyCellValueActivity 450 are shown in the workflow. FIG. 4B shows an example of the Assign (SetCellValueActivity) 452 activity in the workflow in which a specified value is assigned to the target 451. Specifically, the Assign (SetCellValueActivity) 452 assigns a specified value (Expression) 453 to the specified Excel cell or cell range (Target) 451. FIG. 4C shows the Copy (CopyCellValueActivity) 450 activity in the workflow. The Copy (CopyCellValueActivity) 450 activity copies the values from a specified Excel cell or range (Source) 456 to a different Excel cell or range (Target) 458.

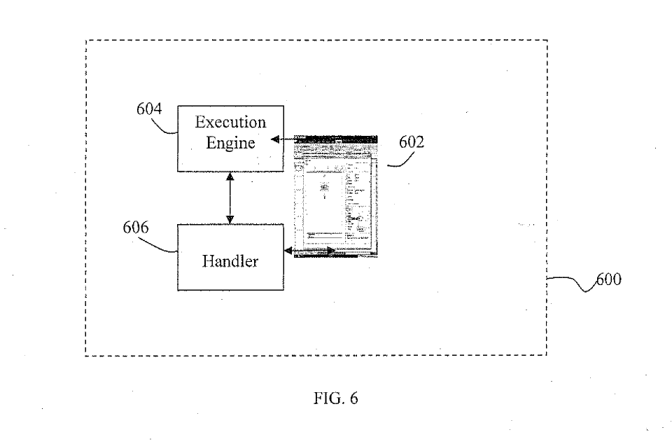

FIG. 5 shows a cell assignment activity (SetCellValueActivity) in connection with the spreadsheet interface 400 provided by the inventive framework. The SetCellValueActivity activity 452 has an associated target 451, which refers to a spreadsheet cell 448, and an expression 449 that should be assigned to the target cell 448 during execution of the activity 452. Here, the value 448 is written to cell A1 of Sheet1 when the workflow consisting of this single activity 452 is executed by the runtime engine.

The SetCellValueActivity activity 452 can be used for inserting formulas into cells during workflow execution allowing one to dynamically change the structure of spreadsheet calculations. Also, using the binding mechanism for activities in a workflow, the value inserted by the SetCellValueActivity activity 452 into a worksheet cell could come from a property of another activity in a workflow. An example would be if one wanted to indicate which branch of an IfElse activity was executed, the Name property of the branch could be inserted into a cell.

### Implementation Examples

The present invention can be implemented using a COM add-in for Microsoft Excel. The add-in provides a user interface integrated with Excel's user interface. FIGS. 1B-1D are screenshots of the Excel user interface 400 integrated with the workflow design COM add-in 402 in accordance with the present invention.

From this user interface 402, one can start the workflow designer 404. This is the standard workflow designer provided by Microsoft as part of Workflow Foundation and used for constructing workflows when hosted in Visual Studio. Here it is hosted in the Excel add-in.

An article with details on re-hosting the workflow designer in applications can be found at http://msdn2.microsoft.com/en-us/library/aa480213.aspx, the entire teachings of which are incorporated by reference.

The interaction between the workflow and the spreadsheet is achieved using custom activities that have been implemented. For instance, the IfElse activity is a customized version of the IfElse activity provided with Workflow Foundation, allowing the user to specify spreadsheet cells as conditions at design time and evaluating the spreadsheet cells at runtime.

When the workflow is run, the add-in invokes the Workflow Foundation runtime engine, providing it with the XAML workflow definition generated by the workflow designer. No separate runtime is required since interaction with Excel is done via custom activities and the Workflow Foundation runtime engine knows how to process such activities.

As workflows are created, they are stored in the Excel document as XAML. Several workflows can exist within the document. The user interface allows for selecting existing workflows 408 for editing or running 406. When the user saves the Excel document, the workflows are persisted as well.

The present invention can be implemented as an app-level add-in for Excel using Microsoft Visual Studio Tools for Office (VSTO). The VSTO runtime loads the present implementation and exposes it to the code methods and events for interacting with Excel. A general description of this architecture can be found at http://msdn2.microsoft.com/en-us/library/bb386298.aspx, the entire teachings of which are incorporated herein by reference.

In addition to running within the VSTO runtime, the present implementation re-hosts the Workflow Designer in Excel. Since the present invention is operating in this environment, custom activities can call methods of the Excel object model and listen to events exposed.

FIG. 6 illustrates an example implementation of the present hybrid spreadsheet workflow design and execution system 600. In at least one embodiment, an event handler 606 is responsive to workflow requests and spreadsheet 602 input manipulating variables in the spreadsheet cells. In communication with the event handler 600, an execution engine 604 creates a hybrid workflow diagram and execution environment using the spreadsheet 602 to implement computer readable code defining a new software application based on the Microsoft Workflow Foundation software engineering methodology.

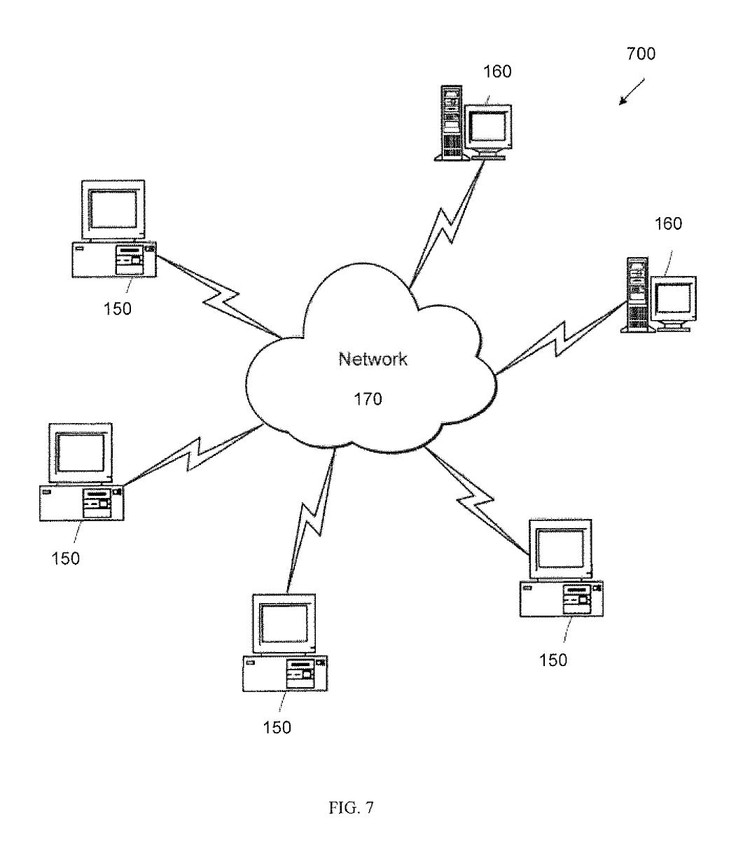

FIG. 7 illustrates a computer network or similar digital processing environment 700 in which the present invention may be implemented. Client computer(s)/devices 150 and server computer(s) 160 provide processing, storage, and input/output devices executing application programs and the like. Client computer(s)/devices 150 can also be linked through communications network 170 to other computing devices, including other client devices/processes 150 and server computer(s) 160. Communications network 170 can be part of a remote access network, a global network (e.g., the Internet), a worldwide collection of computers, Local area or Wide area networks, and gateways that currently use respective protocols (TCP/IP, Bluetooth, etc.) to communicate with one another. Other electronic device/computer network architectures are suitable.

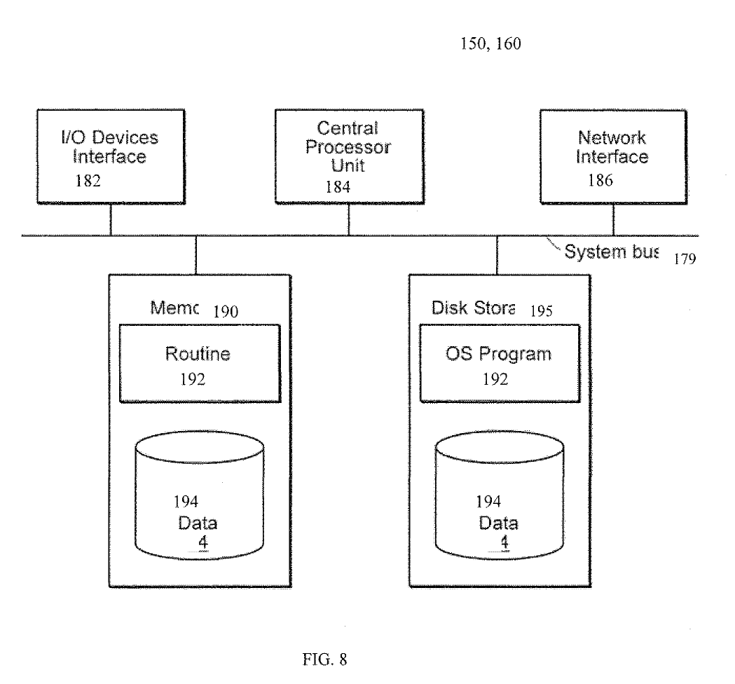

FIG. 8 is a diagram of the internal structure of a computer (e.g., client processor/device 150 or server computers 160). Each computer 150, 160 contains system bus 179, where a bus is a set of hardware lines used for data transfer among the components of a computer or processing system. Bus 179 is essentially a shared conduit that connects different elements of a computer system (e.g., processor, disk storage, memory, input/output ports, network ports, etc.) that enables the transfer of information between the elements. Attached to system bus 179 is an Input/Output (I/O) device interface 182 for connecting various input and output devices (e.g., keyboard, mouse, displays, printers, speakers, etc.) to the computer 150, 160. Network interface 86 allows the computer to connect to various other devices attached to a network. Memory 190 provides volatile storage for computer software instructions 192 and data 194 used to implement an embodiment of the present invention (hybrid spreadsheet workflow design and execution system). Disk storage 195 provides non-volatile storage for computer software instructions 192 and data 194 used to implement an embodiment of the present invention. Central processor unit 184 is also attached to system bus 179 and provides for the execution of computer instructions.

In one embodiment, the processor routines 192 and data 194 are a computer program product, including a computer readable medium (e.g., a removable storage medium, such as one or more DVD-ROM's, CD-ROM's, diskettes, tapes, etc.) that provides at least a portion of the software instructions for the invention system. Computer program product can be installed by any suitable software installation procedure, as is well known in the art. In another embodiment, at least a portion of the software instructions may also be downloaded over a cable, communication and/or wireless connection. In other embodiments, the invention programs are a computer program propagated signal product embodied on a propagated signal on a propagation medium (e.g., a radio wave, an infrared wave, a laser wave, a sound wave, or an electrical wave propagated over a global network, such as the Internet, or other network(s)). Such carrier medium or signals provide at least a portion of the software instructions for the present invention routines/program 192.

In alternate embodiments, the propagated signal is an analog carrier wave or digital signal carried on the propagated medium. For example, the propagated signal may be a digitized signal propagated over a global network (e.g., the Internet), a telecommunications network, or other network. In one embodiment, the propagated signal is a signal that is transmitted over the propagation medium over a period of time, such as the instructions for a software application sent in packets over a network over a period of milliseconds, seconds, minutes, or longer. In another embodiment, the computer readable medium of computer program product is a propagation medium that the computer system may receive and read, such as by receiving the propagation medium and identifying a propagated signal embodied in the propagation medium, as described above for computer program propagated signal product.

Generally speaking, the term “carrier medium” or transient carrier encompasses the foregoing transient signals, propagated signals, propagated medium, storage medium and the like.

While this invention has been particularly shown and described with references to preferred embodiments thereof, it will be understood by those skilled in the art that various changes in form and details may be made therein without departing from the scope of the invention encompassed by the appended claims.

For example, the present invention may be implemented in a variety of computer architectures. The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Some examples of optical disks include compact disk-read only memory (CD-ROM), compact disk-read/write (CD-R/W) and DVD.

What is claimed is:

1. A computer implemented method of software programming comprising the steps of:
creating a hybrid workflow diagram and execution environment using a spreadsheet application by:
causing the workflow and the spreadsheet to manipulate variables in the spreadsheet cells; and
using the hybrid workflow design and execution environment to implement computer readable code to create a new executable software application.

2. A computer implemented method of software programming as in claim 1 wherein using the hybrid workflow design and execution environment to implement computer readable code to create a new executable software application further includes executing branches of an IfElse activity using a value of a cell in the spreadsheet, where the IfElse activity controls a portion of the new executable software application.

3. A computer implemented method of software programming as in claim 1 wherein using the hybrid workflow design and execution environment to implement computer readable code to create a new executable software application further includes copying values and formulas between cells, where the copied formulas and values between cells controls a portion of the new executable software application.

4. A computer implemented method of software programming as in claim 1 wherein using the hybrid workflow design and execution environment to implement computer readable code to create a new executable software application further includes defining event handlers using cells in the spreadsheet, where the event handlers control a portion of the new executable software application.

5. A computer implemented method of software programming as in claim 1 wherein the new executable software conforms to a common language runtime (CLR) schema.

6. A computer implemented method of software programming as in claim 1 wherein creating a hybrid workflow diagram and execution environment using a spreadsheet further includes rehosting a software modeling application in a spreadsheet application.

7. A computer implemented method of software programming as in claim 6 wherein rehosting a software modeling application in the spreadsheet application further includes:
creating custom activities capable of calling methods of the spreadsheet's object model; and
creating custom activities capable of listening to events exposed in the spreadsheet application.

8. A computer implemented method of software programming as in claim 7 wherein the software modeling application is Workflow Designer and the spreadsheet application is Excel.

9. A computer system for software programming comprising:
a handler responsive to workflow requests and spreadsheet input manipulating variables in the spreadsheet cells; and
an execution engine in communication with the handler creating a hybrid workflow diagram and execution environment using the spreadsheet to implement computer readable code defining a new software application.

10. A software programming system comprising:
means for creating a hybrid workflow diagram and execution environment using a spreadsheet by:
means for causing the workflow and the spreadsheet to manipulate variables in the spreadsheet cells; and
means for using the hybrid workflow design and execution environment to implement computer readable code to create a new executable software application.
